(19) United States
(12) Patent Application Publication
(10) Pub. No.: US 2005/0071797 A1
(43) Pub. Date: Mar. 31, 2005

(54) Automatic layout system, layout model generation system, layout model verification system, and layout model

(75) Inventor: Takashi Fujii, Tokyo (JP)

Correspondence Address: MCDERMOTT, WILL & EMERY, 600 13th Street, N.W., WASHINGTON, DC, 20005-3096, US

(73) Assignee: RENESAS TECHNOLOGY CORP.

(21) Appl. No.: 10/944,789

(22) Filed: Sep. 21, 2004

(30) Foreign Application Priority Data
Sep. 26, 2003 (JP) JP2003-335168

(51) Int. Cl. G06F 17/50; G06F 9/455

(52) U.S. Cl. 716/12; 716/13; 716/11

(57) ABSTRACT

An automatic layout system generates a layout of a semiconductor device by placing cell layouts each configured to perform a specific function and providing a routing among the cell layouts. The automatic layout system places the cell layouts and provides the routing among the cell layouts based on a layout model which includes graphic information about the cell layouts required to provide the routing among the cell layouts and information about a routing prohibited area in which provision of a routing causes a design rule violation.

### BACKGROUND OF THE INVENTION

1. Field of the Invention

The present invention relates to an automatic layout system for generating a layout of a semiconductor device, a layout model generation system, a layout model verification system, and a layout model. More particularly, the present invention relates to an automatic layout system for generating a layout of a semiconductor device by placing a plurality of cell layouts and providing a routing among the plurality of cell layouts, and a layout model generation system, a layout model verification system, and a layout model.

2. Description of the Background Art

An automatic layout system for a semiconductor device, which is sometimes called an automatic placement/routing device, places a plurality of cell layouts each performing a specific function (which will be hereinafter referred to as “cell layouts”) by an automatic placement process and connects the cell layouts by a routing (which may hereinafter be referred to as a “cell-to-cell routing”) by an automatic routing process, to thereby generate a layout of the semiconductor device.

The automatic routing process of the automatic layout system as briefly mentioned above is performed using a layout model obtained by modeling graphic information or the like about a routing within each cell based on the cell layouts. The obtained layout model includes graphic information about input/output terminals, obstacles to a routing (“routing obstacles”), and the like. More specifically, in the automatic routing process, the cell-to-cell routing is provided so as to be spaced a predetermined distance from the routing obstacles, to connect the input/output terminals respectively included in the plurality of cell layouts by the cell-to-cell routing. Then, the layout of the semiconductor device functioning as desired can be generated.

In the above-described automatic layout system, because of inclusion of the graphic information about the input/output terminals, the routing obstacles, and the like in the layout model (which is sometimes called a “full-shape”), a distance between the input/output terminals or the routing obstacles and the cell-to-cell routing can be correctly grasped in the automatic routing process, so that occurrence of a violation of a design rule (“design rule violation”) can be avoided.

Another type of automatic layout system which avoids occurrence of a design rule violation is disclosed in U.S. Pat. No. 6,374,395 (which will hereinafter be referred to as “U.S. Pat. No. '395”), for example. The automatic layout system disclosed in U.S. Pat. No. '395 overcomes a problem associated with a conventional automatic layout system. Specifically, the conventional automatic layout system suffered from a problem of occurrence of an error in the form of a notch (“notch error”) which is likely to be caused when a via hole is provided in a cell layout. To overcome this problem, the automatic layout system disclosed in U.S. Pat. No. '395 finds a site where a notch error occurs by carrying out a test. Then, the automatic layout system disclosed in U.S. Pat. No. '395 places a metallic portion of the via hole in a region of the cell layout where a notch error is likely to be caused, or fills a notch which have occurred, to eliminate a notch error.

However, in recent years, as semiconductor devices have been further miniaturized, design rules have become more complicated. Hence, a design rule violation which occurs when a cell-to-cell routing is overlaid on a cell layout cannot be avoided in the conventional automatic layout system which uses a layout model in a simple manner. In this regard, one solution to avoid a design rule violation in the conventional automatic layout system is to place an input/output terminal on an upper layer and employ a simple configuration such as a rectangle for the input/output terminal. However, this solution in turn causes another problem of reducing an integration density of a semiconductor device due to poor flexibility in routing. An alternative solution to avoid a design rule violation in the conventional automatic layout system is to provide a cell-to-cell routing and carry out detection of a design rule violation simultaneously. Also the alternative solution causes another problem of significantly increasing a time period required for routing.

On the other hand, the automatic layout system disclosed in U.S. Pat. No. '395 can avoid only a design rule violation associated with a via hole where a notch error occurs. The automatic layout system disclosed in U.S. Pat. No. '395 cannot avoid all design rule violations associated with the other elements including a cell-to-cell routing.

### SUMMARY OF THE INVENTION

It is an object of the present invention to provide an automatic layout system which is capable of avoiding all design rule violations associated with a cell-to-cell routing without reducing an integration density of a semiconductor device and significantly increasing a time period required for routing.

According to one aspect of the present invention, an automatic layout system includes a placement device and a routing device. The placement device places a plurality of cell layouts each configured to perform a specific function. The routing device provides a routing among the plurality of cell layouts. The routing device provides the routing based on a layout model including graphic information about the plurality of cell layouts which is required to provide the routing among the plurality of cell layouts and information about a routing prohibited area in which provision of the routing causes a design rule violation.

In the automatic layout system, the routing device provides the routing based on the layout model including the graphic information required to provide the routing among the cell layouts and the information about the routing prohibited area in which provision of the routing causes a design rule violation. Hence, the automatic layout system can produce an advantage of avoiding all design rule violations associated with a cell-to-cell routing without reducing an integration density of a semiconductor device and significantly increasing a time period for routing.

According to a second aspect of the present invention, a layout model generation system includes a virtual routing unit, a detector, a routing-prohibited-area definition unit, and a layout model generator. The virtual routing unit provides a virtual routing on a plurality of cell layouts each configured to perform a specific function. The detector determines whether or not the virtual routing causes a design rule violation. The routing-prohibited-area definition unit defines a region occupied by the virtual routing which is determined as causing a design rule violation by the detector, as a routing prohibited area. The layout model generator generates a layout model including graphic information required to provide a routing among the plurality of cell layouts and information about the routing prohibited area.

The layout model generation system can produce an advantage of avoiding all design rule violations associated with a cell-to-cell routing without reducing an integration density of a semiconductor device and significantly increasing a time period for routing.

According to a third aspect of the present invention, a layout model verification system includes a virtual routing provision unit, a violation detector, and an error output unit. The virtual routing provision unit provides a virtual routing on a cell layout configured to perform a specific function. The violation detector determines whether or not provision of the virtual routing causes a design rule violation. The error output unit generates information about the virtual routing which is determined as causing a design rule violation by the violation detector, as error information.

In the layout model verification system, the error information useful for avoiding occurrence of a design rule violation in an automatic layout system is obtained, and either addition of information about a routing prohibited area based on the error information or correction of the cell layout based on the error information can be selected.

A fourth aspect of the present invention is directed to a layout model used for placing a plurality of cell layouts each configured to perform a specific function and providing a routing among the plurality of cell layouts. The layout model includes graphic information about the plurality of cell layouts required to provide the routing among the plurality of cell layouts and information about a routing prohibited area in which provision of the routing causes a design rule violation.

Since the layout model includes graphic information about the cell layouts required to provide the routing among the cell layouts and information about a routing prohibited area in which provision of the routing causes a design rule violation, a design rule violation can be avoided in providing a cell-to-cell routing among the cell layouts.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an automatic layout system according to a first preferred embodiment of the present invention.

FIG. 2 illustrates a cell layout according to the first preferred embodiment of the present invention.

FIGS. 3 and 4 illustrate layout models according to a comparative example.

FIG. 5 illustrates a layout model according to the first preferred embodiment of the present invention.

FIGS. 6 and 7 illustrate other cell layouts according to the first preferred embodiment of the present invention.

FIG. 8 is a block diagram of a layout model generation system and an automatic layout system according to a second preferred embodiment of the present invention.

FIGS. 9, 10, 11, 12, and 13 illustrate cell layouts according to the second preferred embodiment of the present invention.

FIG. 14 illustrates a layout model according to the second preferred embodiment of the present invention.

FIG. 15 is a block diagram of a layout model generation system and an automatic layout system according to a third preferred embodiment of the present invention.

FIG. 16 is a block diagram of a layout model verification system according to a fourth preferred embodiment of the present invention.

FIG. 17 illustrates a cell layout according to the fourth preferred embodiment of the present invention.

FIG. 18 illustrates a layout model according to the fourth preferred embodiment of the present invention.

### DESCRIPTION OF THE PREFERRED EMBODIMENTS

Preferred Embodiments

First Preferred Embodiment

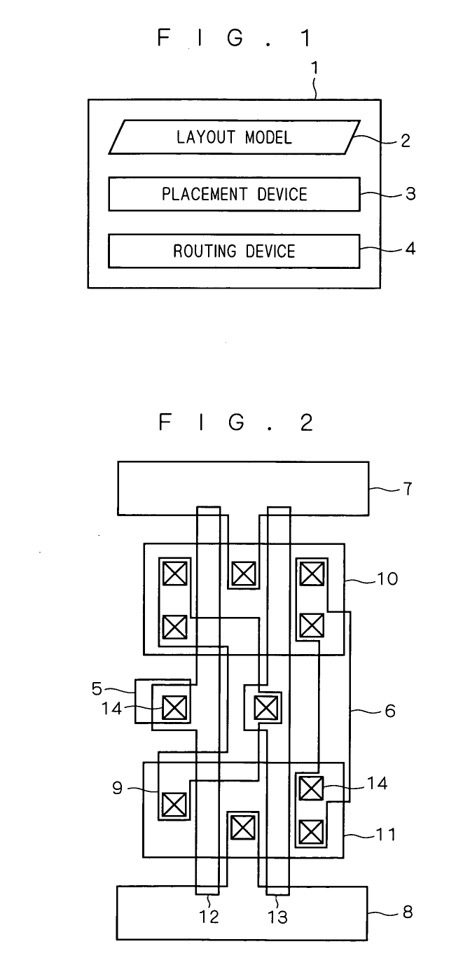

FIG. 1 is a block diagram of an automatic layout system 1 according to a first preferred embodiment. The automatic layout system 1 places a plurality of cell layouts each configured to perform a specific function and provides a routing among the plurality of cell layouts, to thereby generate a layout of a semiconductor device. The automatic layout system 1 is constructed on a computer, and thus is usually in the form of software.

The automatic layout system 1 illustrated in FIG. 1 includes a layout model 2 generated from the plurality of cell layouts each configured to perform a specific function, a placement device 3 for placing the plurality of cell layouts, and a routing device 4 for providing cell-to-cell routings among the cell layouts based on the layout model. With the foregoing structure, the automatic layout system 1 generates a layout of a semiconductor device from the cell layouts. Additionally, the layout model 2 may be generated within the automatic layout system 1 or externally to the automatic layout system 1.

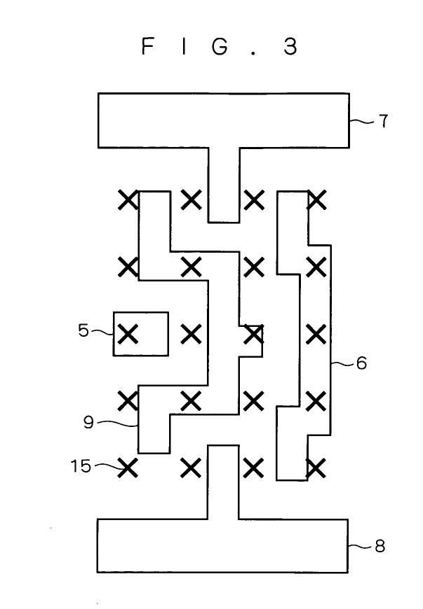

Below, detailed description of the layout model 2 will be given. FIG. 2 illustrates one example of a cell layout according to the first preferred embodiment. The cell layout illustrated in FIG. 2 is a layout of a buffer including two inverters which are disposed at different stages and connected to each other. Specifically, the buffer includes an input/output terminal 5, an input/output terminal 6, a power supply routing 7, a power supply routing 8, and an internal routing 9 which are provided in a first metal routing layer. In FIG. 2, the input/output terminal 5 is located on the left-hand side, the input/output terminal 6 is located on the right-hand side, the power supply routing 7 is located on the top side, the power supply routing 8 is located on the bottom side, and the internal routing 9 is located between the input/output terminals 5 and 6.

The buffer illustrated in FIG. 2 further includes a diffusion layer 10 located on a lower level relative to the input/output terminal 6, the power supply routing 7, and the internal routing 9, and a diffusion layer 11 located on a lower level relative to the input/output terminal 6, the power supply routing 8, and the internal routing 9. Moreover, the buffer includes a gate routing 12 and a gate routing 13 between the first metal routing layer and each of the diffusion layers 10 and 11. The gate routing 12 is connected to the input/output terminal 5 via a contact hole 14, and the gate routing 13 is connected to the internal routing 9 via the contact hole 14. Each of the input/output terminal 6, the power supply routing 7, and the internal routing 9 is connected to the diffusion layer 10 via the contact hole 14. Also, each of the input/output terminal 6, the power supply routing 8, and the internal routing 9 is connected to the diffusion layer 11 via the contact hole 14.

The buffer having the foregoing structure operates as follows. First, a signal is inputted to the input/output terminal 5, and is received by an inverter formed of the gate routing 13, the diffusion layers 10 and 11. Subsequently, an inverted signal is produced and transmitted to the internal routing 9. Then, the inverted signal is outputted to the input/output terminal 6 via the inverter formed of the gate routing 13 and the diffusion layers 10 and 11. The power supply routings 7 and 8 supply a predetermined potential to the inverter.

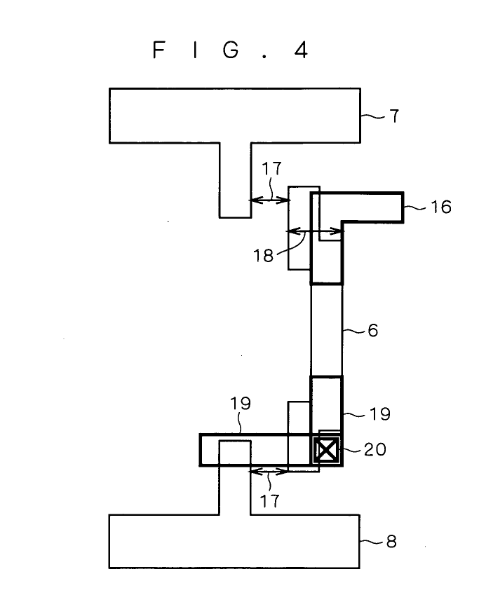

FIG. 3 illustrates one example of a layout model for the cell layout illustrated in FIG. 2. The layout model of FIG. 3 includes only graphic information of the first metal routing layer illustrated in FIG. 2. Graphic information about the gate routings 12 and 13 is not included in the layout model of FIG. 3 because a resistance and a capacitance of polysilicon forming the gate routings 12 and 13 are so high that each of the gate routings 12 and 13 is not recognized as an element to which the cell-to-cell routings are connected. On the other hand, some of the cell-to-cell routings connected to the input/output terminals 5 and 6 should not come into contact with the internal routing 9. Thus, the internal routing 9 is recognized as an obstacle in the layout model. Marks “X” in FIG. 3 indicate grid points 15 which are referred to by the routing device 4 in providing the cell-to-cell routings. However, depending on a type of a device employed as the routing device 4, routing may be performed without referring to the grid points 15.

FIG. 4 illustrates one example of a layout model obtained by providing cell-to-cell routings in a cell layout. The layout model illustrated in FIG. 4 includes a portion (the input/output terminal 6 and the power supply routings 7 and 8) of the layout model illustrated in FIG. 3, which portion is necessary for the following description. First, an L-shaped cell-to-cell routing 16 provided close to a top right-hand corner in FIG. 4 is dealt with. In providing the cell-to-cell routing 16, an attention should be drawn to one of design rules necessary for miniaturization, which requires that a routing with a width equal to or larger than a predetermined depth (which will hereinafter be referred to as a “thick routing”) be spaced a predetermined distance or greater from a routing located in the vicinity of the thick routing. The thick routing has a stronger tendency to increase its thickness after being processed, as compared to a thin routing. Thus, this design rule serves to prevent formation of a short circuit between the thick routing and the routing adjacent to the thick routing, which is likely to be formed due to the foregoing tendency unless the predetermined distance or greater is kept between the thick routing and the adjacent routing.

Before the cell-to-cell routing 16 is provided, a minimum distance 17 between the input/output terminal 6 and the power supply routing 7 is kept in a region where the input/output terminal 6 and the power supply routing 7 are closest to each other, to conform to the foregoing design rule. However, after the cell-to-cell routing 16 is provided, a thick routing 18 including the input/output terminal 6 and the cell-to-cell routing 16 is newly provided in place of the input/output terminal 6. The thick routing 18 is thicker than the input/output terminal 6, and the minimum distance 17 is too small as a distance between the thick routing 18 and the power supply routing 7. As a result, the provision of the cell-to-cell routing 16 causes a design rule violation.

Next, a cell-to-cell routing 19 provided close to a bottom right-hand corner in FIG. 4 is dealt with. The cell-to-cell routing 19 connects elements included in the first metal routing layer and elements included in a second metal routing layer via a through hole 20. After the cell-to-cell routing 19 is provided, the minimum distance 17 between the input/output terminal 6 and the power supply routing 8 becomes too small to conform to the foregoing design rule for the same reasons as given above. Thus, also provision of the cell-to-cell routing 19 causes a design rule violation.

As described above and illustrated in FIG. 4, some regions in a cell layout do not permit provision of a cell-to-cell routing because provision of a cell-to-cell routing causes a design rule violation. As such, according to the first preferred embodiment, a layout model which further includes information about a region in which provision of a cell-to-cell routing causes a design rule violation (design-rule violating region), in addition to the layout model illustrated in FIG. 3, is generated. The layout model 2 in FIG. 1 is a layout model which additionally includes the information about a design-rule violating region.

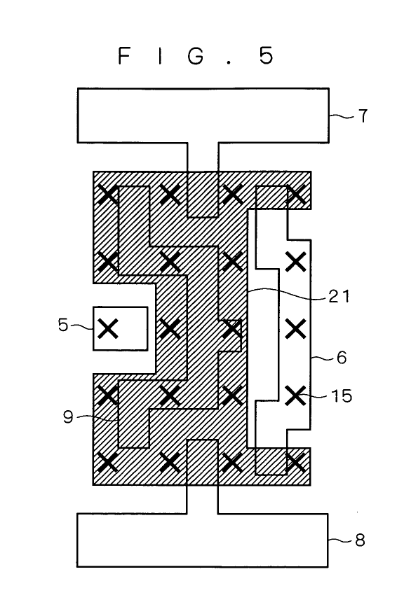

FIG. 5 illustrates a layout model which additionally includes information about a design-rule violating region. The layout model illustrated in FIG. 5 is a layout model for the cell layout illustrated in FIG. 2. The layout model illustrated in FIG. 5 is identical to the layout model illustrated in FIG. 3, except that the information about the design-rule violating region (routing prohibited area 21) is additionally included.

In FIG. 5, analogously to FIG. 2, the input/output terminal 5 is located on the left-hand side, the input/output terminal 6 is located on the right-hand side, the power supply routing 7 is located above the input/output terminals 5 and 6, the power supply routing 8 is located under the input/output terminals 5 and 6, and the internal routing 9 is located between the input/output terminals 5 and 6. Further, the grid points 15 which are referred to in providing routings are included in FIG. 5.

Provision of a cell-to-cell routing which extends from one of the grid points 15 located closest to a top right-hand corner in FIG. 5 toward another grid point 15 located under the one grid point 15 would cause a design rule violation as described above with reference to FIG. 4. Thus, a region around the one grid point 15 is included in the routing prohibited area 21. According to the first preferred embodiment, the routing device 4 is not allowed to provide a cell-to-cell routing in the routing prohibited area 21, so that a design rule violation can be avoided.

In defining the routing prohibited area 21 in the layout model, not only the design rule mentioned above with reference to FIG. 4, but also other design rules, should be taken into consideration. For example, there is a design rule which prohibits existence of successive small steps each having a side with a length equal to or smaller than a predetermined length. With further miniaturization in recent years, adjustment of a light image is required in order to match a pattern on a layout and a pattern on a finished semiconductor substrate. It is noted that for adjustment of a light image, the size of a portion which is expected to be thickened is previously reduced, or the size of a portion which is expected to be thinned is previously increased, for example. Existence of the small steps, however, makes it difficult to adjust a light image, resulting in a considerable difference between a pattern on a layout and a pattern on a finished semiconductor substrate, to likely reduce yield. To provide a cell-to-cell routing in a cell layout causes a step in some cases even if the cell layout includes no step. As such, in defining the routing prohibited area 21, also the foregoing design rule should be taken into consideration, and the results should be reflected in the information about the routing prohibited area 21.

Further, there is another design rule which requires that a hole of a doughnut-shaped portion have an area equal to or larger than a predetermined area. Inclusion of a small hole is likely to cause a resist to be stripped off during manufacture of a semiconductor. As a result, the hole included in a layout is not included in a finished pattern, the stripped resist is attached to an unintended portion to generate an unintended pattern, or some unwanted event occurs. Under those situations, yield is likely to be reduced. Even if a cell layout does not include a hole having an area smaller than the predetermined area, provision of a cell-to-cell routing in the cell layout causes formation of a hole having an area smaller than the predetermined area in some cases. For example, in a case where each of a cell-to-cell routing and a cell layout includes an L-shaped portion, overlap of the respective L-shaped portions of the cell layout and the cell-to-cell routing can form a hole having an area smaller than the predetermined area. As such, in defining the routing prohibited area 21, also the foregoing design rule should be taken into consideration, and the results should be reflected in the information about the routing prohibited area 21.

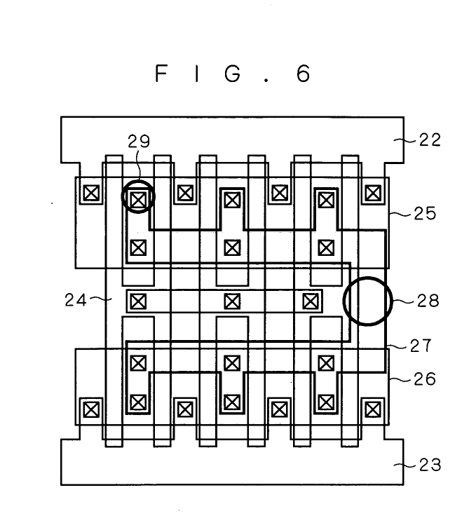

Moreover, a resistance to electromigration may vary depending on a portion to which a routing forming an input/output terminal is connected. FIG. 6 illustrates one example of a cell layout. The cell layout illustrated in FIG. 6 is a layout of an inverter including six PMOS devices and six NMOS devices. Specifically, source routings 22 and 23 are located on the top side and the bottom side of FIG. 6, respectively, and a gate routing 24 extends perpendicularly to the source routings 22 and 23. Also, an n-type diffusion layer 25 is placed on a lower level relative to the source routing 22 and the gate routing 24, and a p-type diffusion layer 26 is located on a lower level relative to the source routing 23 and the gate routing 24. Further, a routing 27 serving as a drain routing for each of the six PMOS devices and the six NMOS devices is provided.

A portion of the routing 27 in which currents outputted from the PMOS devices and the NMOS devices flow together at the time of output of the inverter is made thicker than the other portions, to thereby prevent a break. When the routing device 4 connects a cell-to-cell routing to an access point 28 of the routing 27, a sufficient resistance to electromigration is maintained even with concentration of currents because the access point 28 is included in the thicker portion of the routing 27. On the other hand, when the routing device 4 connects a cell-to-cell routing to an access point 29 of the routing 27, a sufficient resistance to electromigration is lost upon concentration of currents because the access point 29 is included in the other portions than the thicker portion of the routing 27. As such, a design rule regarding a portion which becomes possibly less resistant to electromigration should be taken into consideration, and the results should be reflected in the information about the routing prohibited area 21.

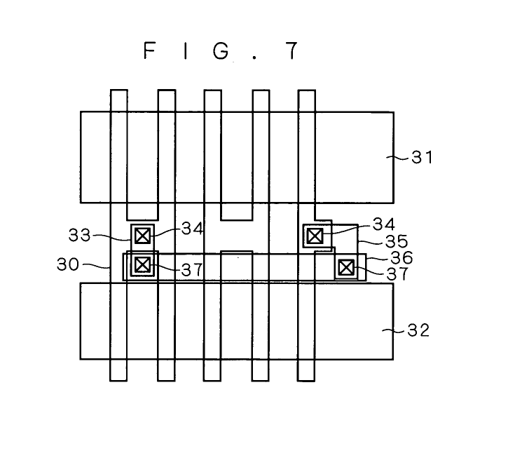

Furthermore, increase in area ratio between a certain gate routing and a metal routing connected to the certain gate routing (area of the metal routing/area of the gate routing) causes dielectric breakdown of a gate oxide film during manufacture of a semiconductor device, resulting in degraded performance of a transistor. That is, there is another design rule which requires that an area ratio of a metal routing to a gate routing be equal to or lower than a predetermined ratio. Thus, the routing device 4 needs to be controlled such that the foregoing area ratio is equal to or lower than a predetermined ratio. FIG. 7 illustrates a portion of a cell layout. The portion of the cell layout illustrated in FIG. 7 includes gate routings 30 vertically extending, an n-type diffusion layer 31, and a p-type diffusion layer 32. The n-type diffusion layer 31 is located in the vicinity of respective top ends of the gate routings 30, and the p-type diffusion layer 32 is located in the vicinity of respective bottom ends of the gate routings 30.

The portion of the cell layout illustrated in FIG. 7 further includes a terminal 33 connected to some of the gate routings 30 via a contact hole 34. The gate routings 30 to which the terminal 33 is connected form two PMOS devices and two NMOS devices. Further, a terminal 35 connected to some of the gate routings 30 via the contact hole 34 is provided. The gate routings 30 to which the terminal 35 is connected form one PMOS device and one NMOS device. Moreover, a terminal 36 which is formed in the second metal routing layer and connected to some of the gate routings 30 via the terminals 33 and 35 and a through hole 37 is provided. The gate routings 30 to which the terminal 36 is connected form three PMOS devices and three NMOS devices.

A total area of the gate routings 30 which are connected to the terminal 36 is larger than a total area of the gate routings 30 which are connected to the terminal 33, or a total area of the gate routings 30 which are connected to the terminal 35. On the other hand, the total area of the gate routings 30 which are connected to the terminal 35 is the smallest. Accordingly, a routing length constraint imposed on a cell-to-cell routing connected to the terminal 36 is the loosest. As such, in defining the routing prohibited area 21, also the foregoing design rule should be taken into consideration, and the results should be reflected in the information about the routing prohibited area 21.

The above-described design rules are mere examples. Other design rules may be taken into consideration and the results are reflected in the information about the routing prohibited area 21, as needed. In the automatic layout system 1 according to the first preferred embodiment, the placement device 3 places a plurality of cell layouts. Then, a cell-to-cell routing connecting the plurality of cell layouts is provided based on the layout model 2 (in particular, the information about the routing prohibited area 21). As a result of such processes, a layout of a semiconductor device can be generated.

As described above, the automatic layout system 1 according to the first preferred embodiment includes the placement device 3 for placing a plurality of cell layouts each configured to perform a specific function, and the routing device 4 for providing a cell-to-cell routing among the cell layouts. The routing device 4 provides the cell-to-cell routing based on the layout model including graphic information of the cell layouts which is required to provide the cell-to-cell routings among the cell layouts, and information about a routing prohibited area in which provision of a cell-to-cell routing causes a design rule violation. Hence, it is possible to avoid all possible design rule violations associated with the cell-to-cell routing without reducing an integration density of a semiconductor device and significantly increasing a time period required for routing.

Also, the layout model 2 according to the first preferred embodiment includes the graphic information of the cell layouts which is required to provide the routing among the cell layouts, and the information about the routing prohibited area in which provision of a routing causes a design rule violation. Hence, it is possible to avoid a design rule violation in providing the cell-to-cell routing among the cell layouts.

It is additionally noted that while a cell-to-cell routing passing though the grid points 15 is preferentially provided, a cell-to-cell routing not passing through the grid points 15 may be provided depending on a type of a routing device employed as the routing device 4. A design rule violation caused by the cell-to-cell routing not passing through the grid points 15 cannot be completely prevented. However, since the cell-to-cell passing through the grid points 15 is preferentially provided, the number of violations can be significantly reduced. Also, when an automatic layout system is of a type that acknowledges a site where a design rule violation occurs and corrects the design rule violation after routing is completed, by defining the routing prohibited area 21, it is possible to significantly reduce the number of design rule violations, as well as reduce a time period required for correction or the number of times of correction after routing.

Moreover, according to the first preferred embodiment, not only a region around each grid point where a design rule violation possibly occurs, but also a region where a cell-to-cell routing cannot be provided because of existence of the internal routing 9, is included in the routing prohibited area 21. Accordingly, even in a case where a cell-to-cell routing not passing through the grid point is possibly provided, the likeliness that a cell-to-cell routing is actually provided away from the grid point is lowered because a whole range in which a cell-to-cell routing can be provided is narrowed.

Second Preferred Embodiment

In a second preferred embodiment, a system for generating the layout model described in the first preferred embodiment, which additionally includes the information about the routing prohibited area, will be described in detail. More specifically, a system for generating a layout model obtained by adding the information about the routing prohibited area to the conventional layout model including only graphic information required to provide a cell-to-cell routing among cell layouts will be described.

FIG. 8 is a block diagram of a layout model generation system 42 and an automatic layout system 49 according to the second preferred embodiment. FIG. 8 also serves as a flow chart of generation of a layout model. In FIG. 8, a cell layout 41 is inputted to the layout model generation system 42. The layout model generation system 42 includes a virtual routing unit 43, a design rule violation detector 44, a routing-prohibited-area definition unit 45, a determination unit 46 for determining whether or not all virtual routings are provided, and a layout model generator 47.

The layout model generation system 42 generates a layout model 48, which is then referred to by the automatic layout system 49. The automatic layout system 49 places the cell layout 41 and provides a cell-to-cell routing based on the layout model 48, to generate a layout 50 of a semiconductor device. The layout model 48 corresponds to the layout model 2 in FIG. 1. The automatic layout system 49 includes the placement device 3 and the routing device 4 described above with reference to FIG. 1.

Next, details of the layout model generation system 42 will be given. In the layout model generation system 42, a cell-to-cell routing is virtually provided to the cell layout 41 by the virtual routing unit 43, first. Subsequently, the design rule violation detector 44 determined whether or not a design rule violation occurs as a result of the cell-to-cell routing having been virtually provided (which will hereinafter be referred to as a “virtual routing”) to the cell layout 41. Design rule violations detected by the design rule violation detector 44 include the design rule violations described in the first preferred embodiment, and the like. Then, a region occupied by the virtual routing which is determined as causing a design rule violation by the design rule violation detector 44 is defined as a routing prohibited area by the routing-prohibited-area definition unit 45.

All possible patterns of routings are virtually provided to the cell layout 41. To this end, the determination unit 46 functions to determine whether or not all possible virtual routings have been provided. If the determination unit 46 determines that all possible virtual routings have been provided, the layout model generator 47 operates. Otherwise, if the determination unit 46 determines that all possible virtual routings have not yet been provided, the virtual routing unit 43 operates again, to provide remaining virtual routings. The layout model generator 47 combines graphic information required to provide a cell-to-cell routing among cell layouts with the information about the routing prohibited area for each virtual routing, to generate the layout model 48.

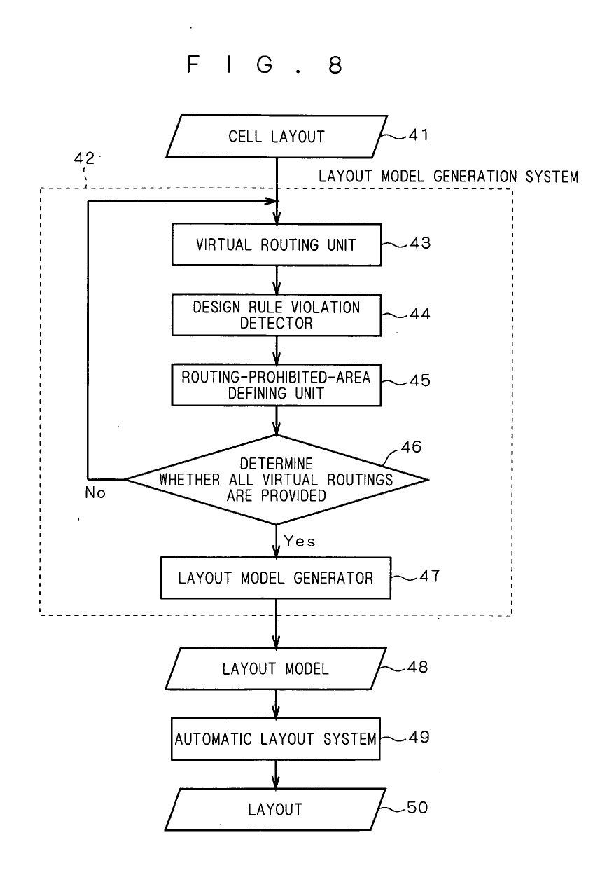

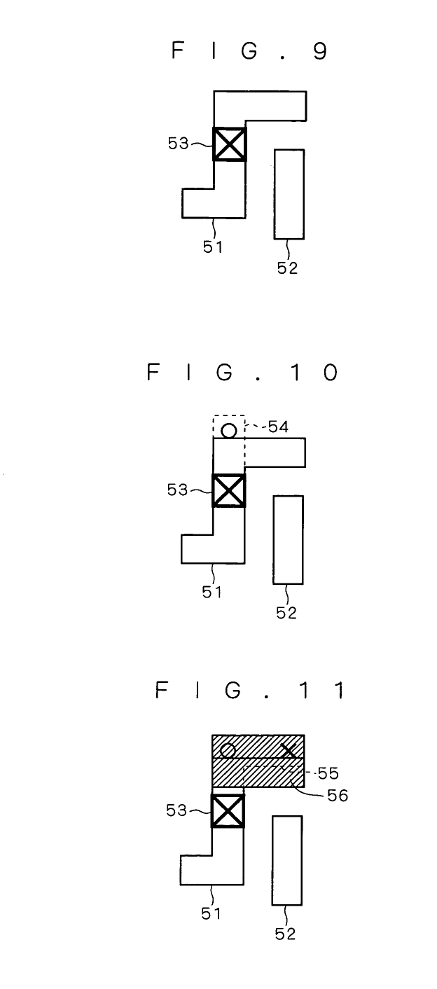

Below, operations of the layout model generation system 42 will be described with a specific example. FIG. 9 illustrates a portion of a cell layout. The portion of the cell layout illustrated in FIG. 9 includes an input/output terminal 51 and an internal routing 52. First, the virtual routing unit 43 selects one access point 53 as a tail end of a cell-to-cell routing. As illustrated in FIG. 9, the access point 53 is located on the input/output terminal 51. The virtual routing unit 43 provides a virtual routing 54 connecting the access point 53 and a grid point adjacent to the access point 53 as illustrated in FIG. 10.

Subsequently, the virtual routing 54 is overlaid on the cell layout and presence or absence of a design rule violation is detected by the design rule violation detector 44. In the present example, no design rule violation occurs as illustrated in FIG. 10. Accordingly, a region occupied by the virtual routing 54 is not defined as a routing prohibited area by the routing-prohibited-area definition unit 45. In FIG. 10, a mark “◯” is drawn to indicate that the virtual routing 54 does not cause a design rule violation.

Since all possible virtual routings have not yet been provided at this stage, the virtual routing unit 43 again operates after determination is made by the determination unit 46. The virtual routing unit 43 provides a different virtual routing 55 connecting a top end of the virtual routing 54 (located opposite to the access point 53) to its adjacent grid point. FIG. 11 illustrates a state where the virtual routing 55 is provided to the cell layout. Then, the virtual routing 55 is overlaid on the cell layout and presence or absence of a design rule violation is detected by the design rule violation detector 44. The virtual routing 55 and the input/output terminal 51 are arranged in contact with each other, to generate a thick routing 56. As a result, a design rule violation is caused in view of a positional relationship between the thick routing 56 and the internal routing 52. Accordingly, a region occupied by the virtual routing 55 is defined as a routing prohibited area by the routing-prohibited-area definition unit 45. In FIG. 11, a mark “X” is drawn to indicate that the virtual routing 55 causes a design rule violation. This surely prevents a cell-to-cell routing passing through the mark “X” from being used by the routing device 4, so that neither provision of another virtual routing connecting the grid point indicated by the mark “X” and its adjacent grid point, nor detection of presence or absence of a design rule violation, is necessary.

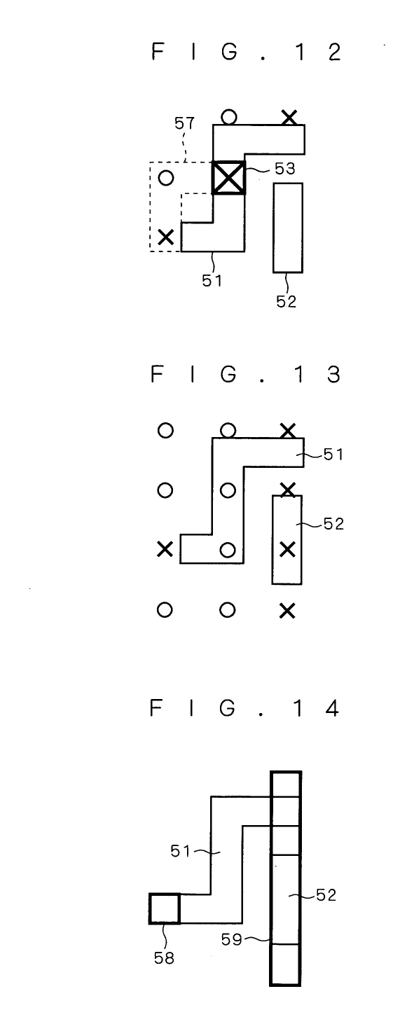

Then, another case where a virtual routing 57 illustrated in FIG. 12 is provided by the virtual routing unit 43 will be described. A portion of the virtual routing 57 which laterally extends from the access point 53 to a grid point indicated by a mark “◯” does not cause a design rule violation. The mark “◯” indicates that no design rule violation is caused by the corresponding portion. However, because of an L shape of the virtual routing 57 illustrated in FIG. 12, a hole having an area smaller than a predetermined area is formed as a result of the virtual routing 57 having been jointed to the input/output terminal 51. Accordingly, the design rule violation detector 44 detects that a design rule violation is caused by the L-shaped virtual routing 57. Consequently, a region occupied by the L-shaped virtual routing 57 is additionally defined as a routing prohibited area by the routing-prohibited-area definition unit 45. In FIG. 12, a mark “X” is drawn at an end of the L shape of the virtual routing 57 in order to indicate that the virtual routing 57 causes a design rule violation.

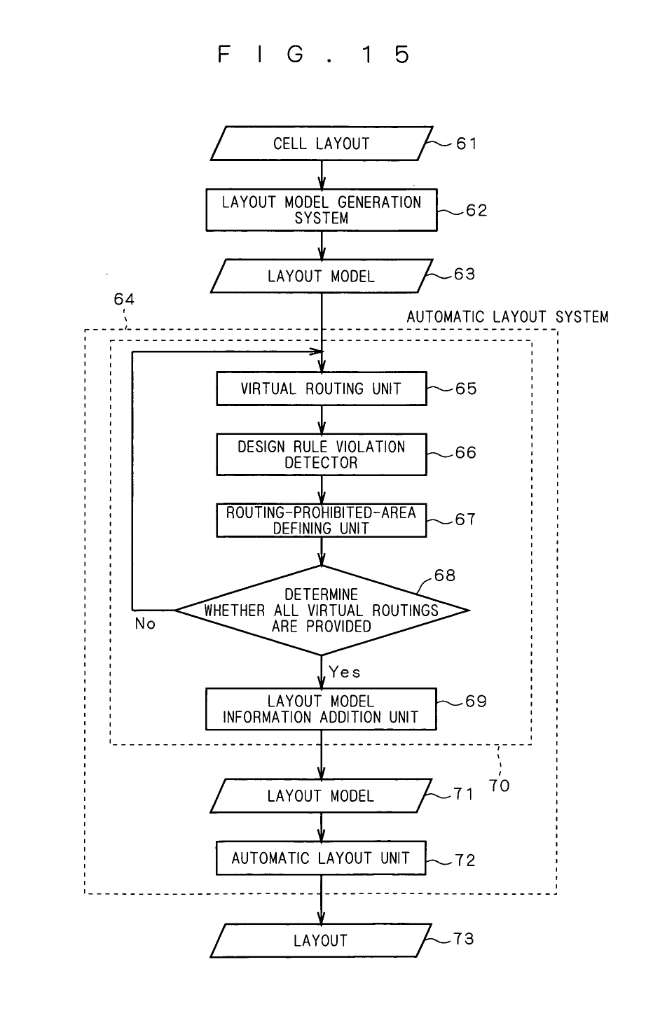

By repeating the above-described processes, each of all grid points in the cell layout illustrated in FIG. 9 is classified as either a grid point at which a design rule violation occurs due to provision of a virtual routing, or a grid point at which a design rule does not occur even with provision of a virtual routing. It is noted that even though one grid point is once classified as a usable grid point because of non-occurrence of design rule violation even with provision of a certain virtual routing, if provision of another virtual routing passing through the same grid point causes a design rule violation, a region around the one grid point is defined as a routing prohibited area. Further, a region around each grid point through which no virtual routing passes in the above processes is recognized as a region where a cell-to-cell routing cannot be provided due to presence of an obstacle such as the internal routing, and is defined as a routing prohibited area. FIG. 13 shows results from provision of all possible virtual routings and detection of design rule violations.

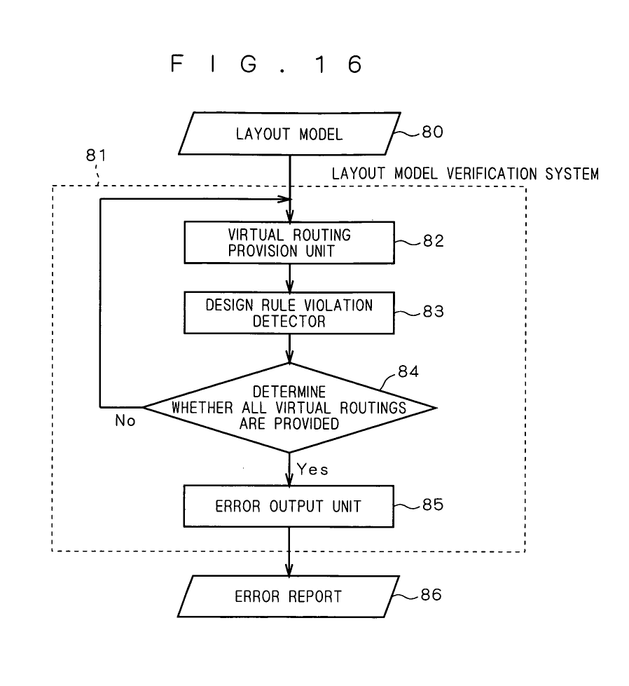

FIG. 14 is a layout model generated based on the results shown in FIG. 13. In FIG. 14, regions around grid points each indicated by the mark “X” in FIG. 13 are defined as routing prohibited areas 58 and 59. It is additionally noted that though the routing prohibited area 59 illustrated in FIG. 14 is one continuous area formed by combining respective regions around a plurality of grid points, each of which is defined as a routing prohibited area by the routing-prohibited-area definition unit 45, the routing prohibited area 59 may alternatively be divided into a plurality of routing prohibited areas respectively formed of the regions around the plurality of grid points each defined as a routing prohibited area.

As described above, the layout model generation system according to the second preferred embodiment includes the virtual routing unit 43 for generating a virtual routing on a cell layout configured to perform a specific function, the design rule violation detector 44 for determining whether or not provision of a virtual routing causes a design rule violation, the routing-prohibited-area definition unit 45 for defining a region occupied by a virtual routing which is determined as causing a design rule violation by the design rule violation detector 44, as a routing prohibited area, and the layout model generator 47 for generating a layout model including graphic information required to provide a routing among cell layouts and information about the routing prohibited area. Hence, the layout model generation system according to the second preferred embodiment can avoid all possible design rule violations associated with a cell-to-cell routing without reducing an integration density of a semiconductor device and significantly increasing a time period required for routing.

Moreover, according to the second preferred embodiment, not only a region around each grid point where a design rule violation occurs, but also a region around each grid point not permitting passage of a cell-to-cell routing because of presence of the internal routing, is defined as a routing prohibited area. However, even without such definition, a cell-to-cell routing cannot pass through the grid point not permitting passage of a cell-to-cell routing because an internal routing serves as an obstacle in a layout model.

According to the second preferred embodiment, the layout model generation system 42 is provided externally to the automatic layout system 49. This makes it possible to avoid all possible design rule violations associated with a cell-to-cell routing without reducing an integration density of a semiconductor device and significantly increasing a time period required for routing. Further, the automatic layout system 49 can be constructed in the minimum size.

Third Preferred Embodiment

The layout model generation system 42 according to the second preferred embodiment is implemented by modifying the conventional layout model generation system which generates a layout model including only graphic information required to provide a routing among cell layouts, so as to be additionally capable of adding information about a routing prohibited area to the layout model. According to a third preferred embodiment, unlike the second preferred embodiment, definition of a routing prohibited area and addition of information about the routing prohibited area are accomplished in an automatic layout system.

FIG. 15 is a block diagram of an automatic layout system 64 according to the third preferred embodiment. FIG. 15 also serves as a flow chart of generation of a layout model. In FIG. 15, a cell layout 61 is inputted to a layout model generator 62. A layout model 63 generated by the layout model generator 62 is inputted to the automatic layout system 64. The layout model generator 62 generates the conventional layout model, and thus the layout model 63 includes only graphic information required to provide a routing among cell layouts.

The automatic layout system 64 includes a virtual routing unit 65, a design rule violation detector 66, a routing-prohibited-area definition unit 67, a determination unit 68 for determining whether or not all possible virtual routings have been provided, and a layout model information addition unit 69. The foregoing elements form a layout model generator 70 within the automatic layout system 64. The virtual routing unit 65, the design rule violation detector 66, the routing-prohibited-area definition unit 67, and the determination unit 68 correspond to the virtual routing unit 43, the design rule violation detector 44, the routing-prohibited-area definition unit 45, and the determination unit 46 according to the second preferred embodiment, respectively.

In the automatic layout system 64, the layout model generator 70 adds information about a routing prohibited area to the layout model 63, to generate a layout model 71. Then, an automatic layout unit 72 in the automatic layout system 64 places the cell layout 61 and provides a cell-to-cell routing based on the layout model 71, to generate a layout 73 of a semiconductor device. The automatic layout unit 72 includes the placement device 3 and the routing device 4 described above with reference to FIG. 1.

Next, details of the layout model generator 70 will be given. First, a cell-to-cell routing is virtually provided (virtual routing) to the layout model 63 by the virtual routing unit 65. Subsequently, the design rule violation detector 66 determines whether or not provision of the virtual routing to the layout model 63 causes a design rule violation. Design rule violations detected by the design rule violation detector 65 include the design rule violations described in the first preferred embodiment, and the like. Then, a region occupied by the virtual routing which is determined as causing a design rule violation by the design rule violation detector 66 is defined as a routing prohibited area by the routing-prohibited-area definition unit 67.

All possible patterns of routings are virtually provided to the layout model 63. To this end, the determination unit 68 functions to determine whether or not all possible virtual routings have been provided. If the determination unit 68 determines that all possible virtual routings have been provided, the layout model information addition unit 69 operates. Otherwise, if the determination unit 68 determines that all possible routings have not yet been provided, the virtual routing unit 65 operates again, to provide remaining virtual routings. The layout model information addition unit 69 adds information about a routing prohibited area to the layout model 63, to generate the layout model 71. The layout model 71 corresponds to the layout model 2 in FIG. 1.

According to the second preferred embodiment, definition of a routing prohibited area is accomplished in the layout model generation system 42 located externally to the automatic layout system. In contrast thereto, according to the third preferred embodiment, definition of a routing prohibited area is accomplished in the automatic layout system 64, instead of the layout model generation system 62 located externally to the automatic layout system 64. This increases flexibility in structure of the automatic layout system. For example, possible change in design rule can be coped with by changing settings of the automatic layout system 64.

The automatic layout system 64 according to the third preferred embodiment includes the layout model generator 70 for generating a layout model. The layout model generator 70 includes the virtual routing unit 65 for generating a virtual routing on a cell layout of a layout model externally inputted, the design rule violation detector 66 for determining whether or not provision of a virtual routing causes a design rule violation, and the routing-prohibited-area definition unit 67 for defining a region occupied by a virtual routing which is determined as causing a design rule violation by the design rule violation detector 66, as a routing prohibited area. Hence, the automatic layout system 64 according to the third preferred embodiment can avoid all possible design rule violations associated with a cell-to-cell routing without reducing an integration density of a semiconductor device and significantly increasing a time period required for routing, in the same manner as in the second preferred embodiment.

Fourth Preferred Embodiment

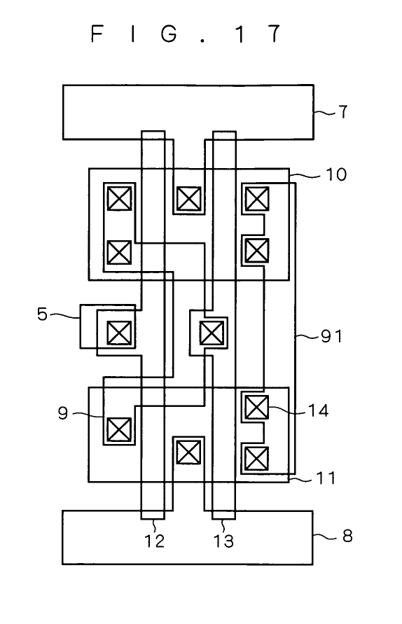

FIG. 16 is a block diagram of a layout model verification system 81 according to a fourth preferred embodiment. FIG. 16 also serves as a flow chart of generation of a layout model. The layout model verification system 81 verifies a cell layout (or layout model) before operations of an automatic layout system, and reflects results of the verification in generation of a layout in the automatic layout system. Additionally, the layout model verification system 81 may be provided within the automatic layout system or externally to the automatic layout system.

In FIG. 16, a layout model 80 is inputted to the layout model verification system 81, first. The layout model 80 corresponds to the layout model 63 in FIG. 15 (the conventional layout model including only graphic information required to provide a routing among cell layouts). In the layout model verification system 81, a virtual routing provision unit 82 provides a virtual routing to the layout model 80. Subsequently, a design rule violation detector 83 overlays the virtual routing on the layout model 80, and detects presence or absence of a design rule violation. Design rule violations detected by the design rule violation detector 83 include the design rule violations described in the first preferred embodiment, and the like.

All possible patterns of routings are virtually provided to the layout model 80. To this end, a determination unit 84 functions to determine whether or not all possible virtual routings have been provided. If the determination unit 84 determines that all possible virtual routings have been provided, an error output unit 85 operates. Otherwise, if the determination unit 84 determines that all possible routings have not yet been provided, the virtual routing provision unit 82 operates again, to provide remaining virtual routings. The error output unit 85 outputs information about a routing prohibited area in which a design rule violation occurs in the layout model 80, as an error report 86. It is additionally noted that the virtual routing provision unit 82, the design rule violation detector 83, and the determination unit 84 correspond to the virtual routing unit 43, the design rule violation detector 44, and the determination unit 46 according to the second preferred embodiment, respectively.

According to the fourth preferred embodiment, either addition of information about a routing prohibited area to a layout model, or correction of a cell layout, can be selectively performed based on the error report 86 outputted from the layout model verification system 81. That is, an optimal operation is performed in the automatic layout system by effectively using the error report 86, to thereby avoid a design rule violation. As described above, it is noted again that the layout model verification system 81 may be provided within the automatic layout system or externally to the automatic layout system.

Below, a specific example of operations of the layout model verification system 81 will be described. Upon input of the layout model illustrated in FIG. 3 to the layout model verification system 81, the error report 86 including information about the routing prohibited area 21 as illustrated in FIG. 5 is obtained. Then, the information about the routing prohibited area 21 is added to the layout model based on the error report 86, and the resulting layout model is processed by the automatic layout system, so that the same results as provided in the first preferred embodiment can be provided. On the other hand, when a cell layout is corrected based on the error report 86, a corrected cell layout as illustrated in FIG. 17 is obtained. The corrected cell layout illustrated in FIG. 17 is different from the cell layout illustrated in FIG. 3 in that an input/output terminal 91 which more closely resembles a straight line is provided in place of the input/output terminal 6.

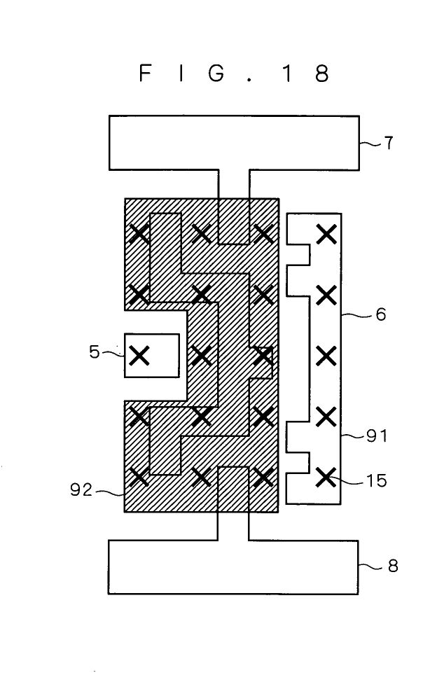

Then, a routing prohibited area 92 illustrated in FIG. 18 different in shape from the routing prohibited area 21 illustrated in FIG. 5 is defined based on the corrected cell layout. The routing prohibited area 92 is different from the routing prohibited area 21 in that a rightward projection is not included. As such, the routing prohibited area 92 illustrated in FIG. 18 is smaller than the routing prohibited area 21, and thus allows more flexible provision of cell-to-cell routings.

As described above, the layout model verification system 81 according to the fourth preferred embodiment includes the virtual routing provision unit 82 for providing a virtual routing on a cell layout configured to perform a specific function, the design rule violation detector 83 for determining whether or not the virtual routing causes a design rule violation, and the error output unit 85 for generating information about the virtual routing which is determined as causing a design rule violation by the design rule violation detector 83, as an error information. Thus, the error report 86 useful for avoiding a design rule violation in the automatic layout system can be obtained. Then, either addition of information about a routing prohibited area based on the error report 86 or correction of the cell layout based on the error report 86 can be selected. Because of the selection, provision of a cell-to-cell routing can be performed more flexibly than in the first preferred embodiment, so that an integration density of a semiconductor device is increased.

In a case where the layout model verification system 81 for verifying a cell layout is provided within the automatic layout system, the automatic layout system includes the layout model verification system 81, and the layout model verification system 81 includes the virtual routing provision unit 82 for providing a virtual routing on a cell layout, the design rule violation detector 83 for determining whether or not the virtual routing causes a design rule violation, and the error output unit 85 for generating information about the virtual routing which is determined as causing a design rule violation by the design rule violation detector 83, as an error information. Then, either addition of information about a routing prohibited area to a layout model based on the error information or correction of the cell layout based on the error information before generation of a layout model can be selected. Hence, provision of a cell-to-cell routing can be performed more flexibly than in the first preferred embodiment, so that an integration density of a semiconductor device is increased.

While the invention has been shown and described in detail, the foregoing description is in all aspects illustrative and not restrictive. It is therefore understood that numerous modifications and variations can be devised without departing from the scope of the invention.

1. An automatic layout system comprising:
a placement device for placing a plurality of cell layouts each configured to perform a specific function; and
a routing device for providing a routing among said plurality of cell layouts, wherein
said routing device provides said routing based on a layout model including graphic information about said plurality of cell layouts which is required to provide said routing among said plurality of cell layouts and information about a routing prohibited area in which provision of said routing causes a design rule violation.

2. The automatic layout system according to claim 1, further comprising
a layout model generation system for generating said layout model, wherein
said layout model generation system includes:
a virtual routing unit for providing a virtual routing on said plurality of cell layouts;
a detector for determining whether or not provision of said virtual routing causes a design rule violation; and
a routing-prohibited-area definition unit for defining a region occupied by said virtual routing which is determined as causing a design rule violation by said detector, as said routing prohibited area.

3. The automatic layout system according to claim 2, wherein
said layout model generation system is provided externally to said automatic layout system.

4. The automatic layout system according to claim 1, further comprising
a layout model verification system for verifying said plurality of cell layouts, wherein
said layout model verification system includes:
a virtual routing provision unit for providing a virtual routing on said plurality of cell layouts;
a violation detector for detecting whether or not provision of said virtual routing causes a design rule violation; and
an error output unit for generating information about said virtual routing which is determined as causing a design rule violation by said violation detector, as error information.

5. The automatic layout system according to claim 2, further comprising
a layout model verification system for verifying said plurality of cell layouts, wherein
said layout model verification system includes:
a virtual routing provision unit for providing a virtual routing on said plurality of cell layouts;
a violation detector for determining whether or not provision of said virtual routing causes a design rule violation; and
an error output unit for generating information about said virtual routing which is determined as causing a design rule violation by said violation detector, as error information.

6. The automatic layout system according to claim 3, further comprising
a layout model verification system for verifying said plurality of cell layouts, wherein
said layout model verification system includes:
a virtual routing provision unit for providing a virtual routing on said plurality of cell layouts;
a violation detector for determining whether or not provision of said virtual routing causes a design rule violation; and
an error output unit for generating information about said virtual routing which is determined as causing a design rule violation by said violation detector, as error information.

7. A layout model generation system comprising:
a virtual routing unit for providing a virtual routing on a plurality of cell layouts each configured to perform a specific function;
a detector for determining whether or not said virtual routing causes a design rule violation;
a routing-prohibited-area definition unit for defining a region occupied by said virtual routing which is determined as causing a design rule violation by said detector, as a routing prohibited area; and
a layout model generator for generating a layout model including graphic information required to provide a routing among said plurality of cell layouts and information about said routing prohibited area.

8. A layout model verification system comprising:
a virtual routing provision unit for providing a virtual routing on a cell layout configured to perform a specific function;
a violation detector for determining whether or not provision of said virtual routing causes a design rule violation; and
an error output unit for generating information about said virtual routing which is determined as causing a design rule violation by said violation detector, as error information.

9. A layout model used for placing a plurality of cell layouts each configured to perform a specific function and providing a routing among said plurality of cell layouts, said layout model comprising:
graphic information about said plurality of cell layouts required to provide said routing among said plurality of cell layouts; and
information about a routing prohibited area in which provision of said routing causes a design rule violation.
